(19) United States
(12) Patent Application Publication
(10) Pub. No.: US 2008/0242532 A1
(43) Pub. Date: Oct. 2, 2008

(54) DIELECTRIC CERAMICS AND MULTI-LAYER CERAMIC CAPACITOR

(75) Inventor: Jun Nishikawa, Gunma (JP)

Correspondence Address: KNOBBE MARTENS OLSON & BEAR LLP, 2040 MAIN STREET, FOURTEENTH FLOOR, IRVINE, CA, 92614, US

(73) Assignee: Taiyo Yuden Co., Ltd., Tokyo (JP)

(21) Appl. No.: 12/054,257

(22) Filed: Mar. 24, 2008

(30) Foreign Application Priority Data
Mar. 26, 2007 (JP) 2007-79050

(51) Int. Cl. C04B 35/462

(52) U.S. Cl. 501/138

(57) ABSTRACT

A multi-layer ceramic capacitor having temperature characteristics capable of satisfying X8R characteristics and having a high specific resistance in a high temperature environment and dielectric ceramics used in the capacitor, the dielectric ceramics containing, as a main ingredient, a compound represented by:

(Bi_{0.5}Na_{0.5})ₓBa₁₋ₓTiO₃

in which x is from 0.05 to 0.2 and containing,

from 0.25 mol to 1.50 mol of at least one rare earth metal selected from Sm, Eu, Gd, Tb, Dy, Ho, Er, Tm, Yb, and Y based on 100 mol of the main ingredient,

from 0.20 mol to 1.5 mol of Mg based on 100 mol of the main ingredient, and

from 0.03 mol to 0.60 mol of at least one metal selected from V, Cr, and Mn based on 100 mol of the main ingredient.

### BACKGROUND OF THE INVENTION

1. Field of the Invention

The present invention concerns dielectric ceramics and a multi-layer ceramic capacitor using them and the invention can provide a multi-layer ceramic capacitor having internal electrodes formed of Ni or Ni alloy and with less temperature change of electrostatic capacity in a temperature range from 150° C. to 200° C.

2. Description of the Related Art

For multi-layer ceramic capacitors used for electronic equipments such as portable equipments and telecommunications equipments, a demand for decreasing the size and increasing the capacitance has been increased more and more. As a small-sized large capacitance multi-layer ceramic capacitor, a multi-layer ceramic capacitor in which an internal electrodes are formed of Ni has been known as disclosed, for example, in JP-A-2001-39765. Such a multi-layer ceramic capacitor can satisfy X7R characteristics (permittivity stays within ±15% in a temperature range from −55° C. to +125° C., with 25° C. as a reference).

However, for the multi-layer ceramic capacitor, reliability under severer circumstances has been required in recent years depending on the application use. For example, multi-layer ceramic capacitors have become used in car-mounted electronic equipments such as electronic engine control units mounted in car engine rooms, antilock brake systems, etc. Since stable operation is demanded for such the car-mounted electronic equipment, in a low temperature environment at −20° C. or lower or a high temperature environment at +130° C. or higher, multi-layer ceramic capacitors used therein have also been demanded to provide a satisfactory temperature stability even under such severe circumstances.

For satisfying such a demand, dielectric ceramic compositions and multi-layer ceramic capacitors capable of satisfying X8R characteristics (permittivity or electrostatic capacity stays within ±15% in a temperature range from −55° C. to +150° C., with 25° C. as a reference) have been proposed, for example, as disclosed in JP-A-2005-272263.

The multi-layer ceramic capacitors disclosed in the JP-A Nos. 2001-39765 and 2005-272263 have dielectric ceramic compositions mainly comprising barium titanate. Barium titanate has a curie point at 125° C. and the permittivity lowers abruptly as the temperature exceeds 125° C. Accordingly, while it is possible to confine permittivity or electrostatic capacity within ±15% in a temperature range from −55° C. to +125° C., it has been extremely difficult to confine the rate of permittivity or rate of change of electrostatic capacity within ±15% also including a temperature range that exceeds 125° C. In a case of further decreasing the thickness of dielectric ceramics between the internal electrodes for further decreasing the size and increasing the capacity, there has been a problem that no sufficient insulation resistance can be obtained. Particularly, there have been problems that no sufficient insulation resistance can be obtained under a high temperature environment exceeding 125° C.

### SUMMARY OF THE INVENTION

The present invention provides a multi-layer ceramic capacitor having temperature characteristics capable of satisfying X8R characteristics and having an insulation resistance in a high temperature environment of 100 MΩ·m or higher being converted as a specific resistance of dielectric ceramics between internal electrodes. The invention also provides dielectric ceramics for use in the multi-layer ceramic capacitor described above.

In one embodiment,

dielectric ceramics comprise, as a main ingredient, a compound having a perovskite structure represented by:

(Bi_{0.5}Na_{0.5})ₓBa₁₋ₓTiO₃

in which x is from 0.05 to 0.2, and containing,

from 0.25 mol to 1.5 mol of at least one rare earth metal selected from Sm, Eu, Gd, Tb, Dy, Ho, Er, Tm, Yb, and Y, being converted as one oxide of one atom in one molecule, from 0.2 mol to 1.5 mol of Mg being converted as one oxide of one atom in one molecule, and

from 0.03 mol to 0.60 mol of at least one metal selected from V, Cr, and Mn being converted as an oxide of one atom in one molecule, based on 100 mol of the main ingredient, and,

SiO₂ or a glass ingredient mainly comprising SiO₂.

In one embodiment, dielectric ceramics that can be used for a multi-layer ceramic capacitor having temperature characteristics capable of satisfying the X8R characteristics and having specific resistance of 100 MΩ·m or higher in a high temperature environment of 125° C. to 200° C. can be obtained.

In further embodiments, a multi-layer ceramic capacitor comprises multi-layer ceramics of a substantially hexahedral shape, internal electrodes formed in the multi-layer ceramics such that they are opposed in the multi-layer ceramics by way of the dielectric ceramics and led to different end faces alternately, and external electrodes formed on both end faces of the multi-layer ceramics and electrically connected with the internal electrodes led to the end faces respectively, in which the dielectric ceramics are formed of dielectric ceramics and the internal electrodes are formed of Ni or Ni alloy.

In other embodiments, a multi-layer ceramic capacitor has temperature characteristics capable of satisfying the X8R characteristics, has an insulation resistance of 100 MΩ·m or higher in a high temperature environment at 125° C. to 200° C. and, further, has a high temperature acceleration life time property of 10,000 sec or more at 200° C.—20V/μm.

In further embodiments a multi-layer ceramic capacitor has the temperature characteristics capable of satisfying the X8R characteristics, has the insulation resistance of 100 MΩ·m or higher in a high temperature environment and, further, has a high temperature acceleration life time property of 10,000 sec or more at 200° C.—20 V/μm. Further embodiments of the invention include dielectric ceramics for use in the multi-layer ceramic capacitor described above.

### BRIEF DESCRIPTION OF THE DRAWING

FIG. 1 is a schematic view showing a cross section of a multi-layer ceramic capacitor.

### DESCRIPTION OF THE PREFERRED EMBODIMENTS

In one embodiment, the dielectric ceramics can be formed by using (Bi_{0.5}Na_{0.5})ₓBa₁₋ₓTiO₃ as a main ingredient and mixed therewith a first material containing an oxide of Mg, at least one metallic oxide selected from V, Cr and Mn, and an oxide of at least one rare earth metal selected from Sm, Eu, Gd, Tb, Dy, Ho, Er, Tm, Yb, and Y, and a second material comprising SiO₂ or a glass ingredient such as B₂O₃—SiO₂ series glass or Li₂O—SiO₂ series glass, the compositional ratio described above and sintering them.

In one embodiment, the dielectric ceramics can be obtained as described below. At first, (Bi_{0.5}Na_{0.5})ₓBa₁₋ₓTiO₃ as the main ingredient can be synthesized. For example, as the starting material, 1-x mol of BaCO₃, 0.25× mol of Bi₂O₃, and 0.25× mol of Na₂CO₃ are provided based on 1 mol of TiO₂ and weighed such that x is within a range from 0.05 to 0.2. Water can be added to the starting materials and they can be wet blended by using a ball mill, bead mill, or dispamil. The mixture can be dried and the dried product can be calcined being kept at 900° C. for one hour to obtain a powder of (Bi_{0.5}Na_{0.5})ₓBa₁₋ₓTiO₃ as the main ingredient. In the (Bi_{0.5}Na_{0.5})ₓBa₁₋ₓTiO₃, the curie point shifts to a higher temperature side than that for BaTiO₃, and has a curie point in a range from 150° C. to 200° C. Accordingly, lowering of the permittivity at 125° C. to 200° C. is decreased compared with existent dielectric ceramics using BaTiO₃, and the rate of permittivity change can easily be confined within ±15%.

Based on 100 mol of the powder of the obtained main ingredient, 0.25 mol to 1.5 mol of a rare earth metal being converted as an oxide of one atom in one molecule, 0.2 mol to 1.5 mol of Mg being converted as an oxide of one atom in one molecule, and from 0.03 mol to 0.60 mol of a transition metal such as V, Cr or Mn being converted as an oxide of one atom in one molecule are added and, further, SiO₂ or a glass ingredient mainly comprising SiO₂ can be added. They may be wet blended and dried to form a dielectric ceramic composition. The dielectric ceramic composition may be used for forming the dielectric ceramic layer of a multi-ceramic capacitor. Being converted as an oxide of one atom in one molecule means conversion into an oxide having one metal atom in one molecule. For example, Ho₂O₃ is converted as HoO_{3/2}. SiO₂ or the glass ingredient mainly comprising SiO₂ can be added for sintering the dielectric ceramics at 1150 to 1400° C. While the additive amount is not restricted particularly, SiO₂ or the glass ingredient mainly comprising SiO₂ is preferably added by 0.5 to 20 mass parts based on 100 mass parts of the main ingredient in order that the glass ingredient is not deposited after sintering between the dielectric ceramics and the internal electrodes and lowers of the permittivity.

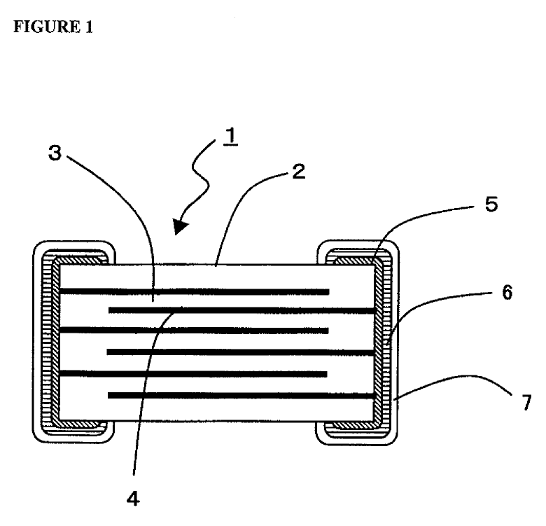

As shown in FIG. 1, a multi-layer ceramic capacitor 1 of this embodiment has substantially hexahedron multi-layer ceramics 2 having dielectric ceramics 3 and internal electrodes 4 formed such that they are opposed by way of the dielectric ceramics 3 and led out to different end faces alternatively, and external electrodes 5 are formed on both end faces of the multi-layer ceramics 2 so as to be electrically connected with the internal electrodes. On the external electrode 5, a first plating layer 6 for protecting the external electrode 5 and a second plating layer 7 for improving the solder wetting property are formed optionally on the external electrode 5.

A method of manufacturing the multi-layer ceramic capacitor can be described. A dielectric ceramic composition of the invention can be prepared. A butyral-based or acrylic-based organic binder, a solvent and other additives can be mixed to form a ceramic slurry. The ceramic slurry can be sheeted by using a coating device such as a roll coater to form a ceramic green sheet of a predetermined thickness as dielectric ceramics.

A conductive paste of an Ni or Ni based alloy may be coated in a predetermined pattern-shape by screen printing on the ceramic green sheet to form a conductive layer as an internal electrode. After laminating ceramic green sheets each formed with the conductive layer by a required number, they can be press bonded to form uncalcined ceramic layered body. After cutting and dividing the same into individual chips, the binder is removed in an atmospheric air or a non-oxidation gas such as nitrogen.

After removing the binder, a conductive paste can be coated to the internal electrode exposure surface of the individual chip to form a conductive film as an external electrode 5 An individual chip formed with the conductive film can be baked in a nitrogen-hydrogen atmosphere at a predetermined temperature (oxygen partial pressure: about 10⁻¹⁰ atm). The external electrode 5 may be prepared also by baking an individual chip to form multi-layer ceramics 2 and then coating and baking a conductive paste containing glass frits to the internal electrode exposure surface. For the external electrode 5, a metal identical with that of the internal electrode can be used, as well as Ag, Pd, AgPd, Cu, or Cu alloy can be used. Further, a first plating layer 6 can be formed with Ni, Cu, etc. on the external electrode 5, and a second plating layer 7 can be formed with Sn or Sn alloy further thereon to obtain a multi-layer ceramic capacitor 1.

### EXAMPLES

At first, as the starting material for the main ingredient (Bi_{0.5}Na_{0.5})ₓBa₁₋ₓTiO₃, BaCO₃, TiO₂, Bi₂O₃, and Na₂CO₃ were weighed and prepared such that x had a value in Table-1 while considering, for example, the amount reached as ions in the subsequent wet blending or amount that evaporates during baking. Then, those provided starting materials were wet blended for 15 hr by a ball mill, dried and then calcined at 900° C. for one hour to obtain a powder of a main ingredient. Usual BaTiO₃ was adopted for No. 1.

TABLE 1

| | | (Bi_{0.5}Na_{0.5})ₓBa₁₋ₓTiO | Rare earth | | Mg | Transition metal M | |
|---|---|---|---|---|---|---|---|
| | No. | x | Additive amount (mol) | | Additive amount (mol) | Additive amount (mol) | |
| * | 1 | 0 | Ho | 1.0 | 1.0 | Mn | 0.10 |
| | 2 | 0.05 | Ho | 1.0 | 1.0 | Mn | 0.10 |
| | 3 | 0.07 | Ho | 1.0 | 1.0 | Mn | 0.10 |
| | 4 | 0.1 | Ho | 1.0 | 1.0 | Mn | 0.10 |
| | 5 | 0.15 | Ho | 1.0 | 1.0 | Mn | 0.10 |
| | 6 | 0.2 | Ho | 1.0 | 1.0 | Mn | 0.10 |
| * | 7 | 0.25 | Ho | 1.0 | 1.0 | Mn | 0.10 |
| * | 8 | 0.1 | Ho | 0.1 | 1.0 | Mn | 0.10 |
| | 9 | 0.1 | Ho | 0.25 | 1.0 | Mn | 0.10 |
| | 10 | 0.1 | Ho | 1.0 | 0.2 | Mn | 0.60 |
| | 11 | 0.2 | Ho | 1.0 | 1.5 | Mn | 0.10 |
| | 12 | 0.1 | Ho | 1.5 | 1.0 | Mn | 0.10 |
| * | 13 | 0.1 | Ho | 2.0 | 1.0 | Mn | 0.10 |
| * | 14 | 0.1 | Ho | 1.0 | 0.1 | Mn | 0.10 |
| | 15 | 0.1 | Ho | 1.0 | 0.2 | Mn | 0.10 |
| | 16 | 0.1 | Ho | 1.5 | 1.0 | Mn | 0.03 |
| | 17 | 0.07 | Ho | 1.0 | 1.0 | Mn | 0.60 |
| | 18 | 0.1 | Ho | 1.0 | 1.5 | Mn | 0.10 |
| * | 19 | 0.1 | Ho | 1.0 | 2.0 | Mn | 0.10 |
| * | 20 | 0.1 | Ho | 1.0 | 1.0 | Mn | 0.00 |
| | 21 | 0.1 | Ho | 1.0 | 1.0 | Mn | 0.03 |
| | 22 | 0.1 | Ho | 0.25 | 1.5 | Mn | 0.10 |
| | 23 | 0.2 | Ho | 1.5 | 0.2 | Mn | 0.10 |
| | 24 | 0.1 | Ho | 1.0 | 1.0 | Mn | 0.60 |
| * | 25 | 0.1 | Ho | 1.0 | 1.0 | Mn | 1.00 |
| | 26 | 0.1 | Y | 1.0 | 1.0 | Mn | 0.10 |
| | 27 | 0.1 | Sm | 1.0 | 1.0 | Mn | 0.10 |
| | 28 | 0.1 | Eu | 1.0 | 1.0 | Mn | 0.10 |
| | 29 | 0.1 | Gd | 1.0 | 1.0 | Mn | 0.10 |
| | 30 | 0.1 | Tb | 1.0 | 1.0 | Mn | 0.10 |
| | 31 | 0.1 | Dy | 1.0 | 1.0 | Mn | 0.10 |
| | 32 | 0.1 | Er | 1.0 | 1.0 | Mn | 0.10 |
| | 33 | 0.1 | Tm | 1.0 | 1.0 | Mn | 0.10 |
| | 34 | 0.1 | Yb | 1.0 | 1.0 | Mn | 0.10 |
| | 35 | 0.1 | Dy:Ho | 1.0 | 1.0 | Mn | 0.10 |
| | 36 | 0.1 | Ho | 1.0 | 1.0 | V | 0.10 |
| | 37 | 0.1 | Ho | 1.0 | 1.0 | Cr | 0.10 |
| | 38 | 0.1 | Ho | 1.0 | 1.0 | V:Mn | 0.10 |

*Out of the range of the invention

Then, the oxide of the rare earth metal, MgO, and the oxide of the transition metal were added each in an amount shown in Table 1 being converted as an oxide of one atom in one molecule based on 100 mol of the obtained main ingredient (Bi_{0.5}Na_{0.5})ₓBa₁₋ₓTiO₃. Further, SiO₂ was added by 10 mass parts based on 100 mass parts of the main ingredient (Bi_{0.5}Na_{0.5})ₓBa₁₋ₓTiO₃ and the mixture was wet blended for 15 hours in a ball mill, and dried to obtain a dielectric ceramic powder.

Polyvinyl butyral, an organic solvent and a plasticizer were added and mixed to the powder described above to form a ceramic slurry. The ceramic slurry was coated and sheeted on a PET film by a roll coater to obtain a long ceramic green sheet of 5 μm thickness and 20 cm width. An Ni internal electrode paste was coated on the ceramic green sheet by screen printing to form an internal electrode pattern in which paste films each of a 7.6 mm×1.6 mm rectangle-shape are arranged in a grid-shape each at 0.4 mm distance. The ceramic green sheet formed with the internal electrode pattern was punched into a 15 cm×15 cm size, and stacked by the number of 21 sheets while displacing the internal electrode patterns each by one-half pattern alternately in the longitudinal direction to form a layered body. The layered body was press bonded and then cut and divided each into a 4.0 mm×2.0 mm size to form a raw chip. The binder was removed from the raw chip in a nitrogen atmosphere at 500° C., and an Ni external electrode paste was coated and baked being kept in a reducing atmosphere (nitrogen-hydrogen atmosphere, oxygen partial pressure: 10⁻¹⁰ atm) by keeping at 1200° C. for one hour and then the temperature was lowered to a room temperature at a temperature-fall speed of 750° C./hr.

For the thus obtained multi-layer ceramic capacitors each sized 3.2×1.6 mm, with the thickness of the dielectric ceramics layer of 3 μm, rate of capacitance change (temperature characteristics), insulation resistances and high temperature acceleration life time property were measured and collectively shown in Table 2. The rate of capacitance change was shown as the rate of change based on the electrostatic capacity at 25° C. as a reference. Further, the rate of capacitance change was within a range of +15% for the range from −55° C. to 125° C., for each of the samples excepting for sample No. 7. For the insulation resistance, a resistance was measured at a temperature of 200° C. and at a measuring voltage of 7 V/μm with the measuring terminal of a mega ohmmeter being in contact with the external electrode, and a specific resistance was calculated based on the intersection area of the internal electrodes and the thickness of the dielectric ceramics between the internal electrodes. This was carried out for the sample each selected at random by the number of 10 and an average value thereof was taken. Further, the high temperature acceleration life time property was measured for the samples selected at random by the number of 10 at 200° C. and under a load of 20 V/μm and an average value for the time where the resistance of the 10 specimens was lowered to 1 MΩ·m or lower.

TABLE 2

| | | | | | | | Acceler- |
|---|---|---|---|---|---|---|---|
| | | | | | | Specific | ation |
| | | Rate of capacitance change | | | | resistance | life time |
| | No. | 125° C. | 150° C. | 175° C. | 200° C. | Ω · m | (sec) |
| * | 1 | −10.6 | −22.2 | −23.7 | −25.0 | 2.0E+09 | 7.2E+04 |
| | 2 | −11.8 | −10.1 | −11.1 | −23.4 | 1.2E+09 | 6.9E+04 |
| | 3 | −12.5 | −11.1 | −10.2 | −16.8 | 9.3E+08 | 7.0E+04 |
| | 4 | −13.8 | −12.8 | −12.0 | −11.2 | 9.1E+08 | 6.8E+04 |
| | 5 | −14.2 | −13.3 | −12.9 | −11.6 | 9.0E+08 | 6.6E+04 |
| | 6 | −14.2 | −13.4 | −13.2 | −12.1 | 6.8E+08 | 6.5E+04 |
| * | 7 | −15.5 | −13.9 | −13.6 | −12.9 | 3.9E+08 | 3.9E+04 |
| * | 8 | −9.8 | −7.9 | −8.2 | −10.9 | 6.9E−06 | 0 |
| | 9 | −11.9 | −12.9 | −12.7 | −12.4 | 4.2E+08 | 4.5E+04 |
| | 10 | −11.2 | −11.6 | −12.4 | −12 | 2.9E+08 | 8.8E+04 |
| | 11 | −14.8 | −14.1 | −12.9 | −11.9 | 7.2E+08 | 5.4E+04 |
| | 12 | −14.1 | −12.9 | −11.1 | 10.7 | 1.1E+09 | 7.6E+04 |
| * | 13 | Characteristics cannot be evaluated due to lack of sinterability | | | | | |
| * | 14 | −9.8 | −10.9 | −13.1 | −15.6 | 5.5E+07 | 3.0E+03 |
| | 15 | −11.6 | −11.7 | −12.3 | −13.9 | 3.8E+08 | 4.3E+04 |
| | 16 | −13.4 | −12.7 | −10.9 | −10.2 | 1.9E+09 | 6.1E+04 |
| | 17 | −12.6 | −12 | −11.1 | −15.9 | 4.4E+08 | 7.9E+04 |
| | 18 | −13.5 | −12.5 | −12.4 | −12.1 | 8.8E+08 | 9.3E+04 |
| * | 19 | Characteristics cannot be evaluated due to lack of sinterability | | | | | |
| * | 20 | −13.4 | −12.3 | −12.2 | −11.9 | 4.9E+05 | 0 |
| | 21 | −13.5 | −12.8 | −12.4 | −12.1 | 1.8E+09 | 4.4E+04 |
| | 22 | −12.1 | −13.4 | −12.5 | −12.1 | 5.1E+08 | 6.1E+04 |
| | 23 | −12.1 | −12.5 | −12.9 | −13.9 | 5.4E+08 | 3.7E+04 |
| | 24 | −14 | −12.9 | −12.6 | −13.0 | 5.5E+08 | 9.6E+04 |
| * | 25 | −14.1 | −12.9 | −12.8 | −12.7 | 3.3E+07 | 7.1E+04 |
| | 26 | −12.9 | −12.8 | −12.4 | −11.2 | 7.9E+08 | 6.3E+04 |
| | 27 | −13.5 | −11.9 | −10.9 | −10.9 | 6.8E+08 | 2.2E+04 |
| | 28 | −13.4 | −11.9 | −10.9 | −10.8 | 5.5E+08 | 2.1E+04 |
| | 29 | −13.5 | −12.0 | −11.4 | −11.2 | 7.2E+08 | 3.2E+04 |
| | 30 | −12.8 | −13.0 | −12.5 | −12.0 | 8.1E+08 | 4.3E+04 |
| | 31 | −13.9 | −13.1 | −12.0 | −11.3 | 9.6E+08 | 8.4E+04 |
| | 32 | −13.2 | −12.8 | −12.3 | −11.8 | 9.4E+08 | 5.9E+04 |
| | 33 | −13.0 | −12.1 | −12.0 | −11.7 | 7.6E+08 | 5.5E+04 |
| | 34 | −12.9 | −12.7 | −12.0 | −11.3 | 5.5E+08 | 3.1E+04 |
| | 35 | −13.1 | −12.5 | −11.9 | −11.5 | 9.7E+08 | 7.7E+04 |
| | 36 | −13.0 | −13.1 | −12.3 | −12.0 | 8.7E+08 | 8.8E+04 |
| | 37 | −12.9 | −11.9 | −12.1 | −12.0 | 9.3E+08 | 8.6E+04 |
| | 38 | −13.5 | −13.1 | −12.5 | −11.5 | 9.0E+08 | 7.5E+04 |

*Out of the range of the invention

Based on the result for sample Nos 1 to 7 with the value x being changed, dielectric ceramics having temperature characteristics capable of satisfying X8R characteristics and having a specific resistance of 100 MΩ·m or higher in a high temperature environment can be obtained by defining the value x in (Bi_{0.5}Na_{0.5})ₓBa₁₋ₓTiO₃ as the main ingredient to a range of 0.05 to 0.20. Further, a multi-layer ceramic capacitor having a high temperature acceleration life time property exceeding 10,000 sec or more in a case at 200° C.—20 V/μm. Further, by changing rate of x as within a range from 0.1 to 0.2, temperature characteristics that the rate of electrostatic capacity change is within a ±15% range at 25° C. as a reference for a temperature range from −55° C. to 200° C. can be obtained. In a case where the value x was out of the range of the invention, the rate of electrostatic capacity change at 25° C. reference did not fall within ±15% range within the temperature range of 125° C. to 200° C.

Based on the result for the samples Nos. 8 to 13 with the additive amount of the oxide of the rare earth metal (Ho) being increased or decreased, dielectric ceramics having temperature characteristics capable of satisfying the X8R characteristics and having a specific resistance of 100 MΩ·m or higher in a high temperature environment could be obtained by defining the additive amount to a range from 0.25 mol to 1.50 mol based on 100 mol of the main ingredient and, further, a multi-layer ceramic capacitor having a high temperature acceleration life time property of 10,000 sec or more at 200° C.—20 V/μm could be obtained. In a case where the additive amount of the oxide of the rare earth metal was out of the range of the invention, sintering failure was caused or the specific resistance in the high temperature environment was lower than 100 MΩ·m, and the high temperature acceleration life time property was less than 10,000 sec at 200° C.—20 V/μm.

Based on the result for samples Nos. 14 to 19 with the additive amount of the oxide of Mg being increased or decreased, dielectric ceramics having temperature characteristics capable of satisfying the X8R characteristics and having a specific resistance of 100 MΩ·m or higher in a high temperature environment could be obtained by defining the additive amount to a range from 0.20 mol to 1.50 mol based on 100 mol of the main ingredient and, further, a multi-layer ceramic capacitor having a high temperature acceleration life time property of 10,000 sec or more at 200° C.—20 V/μm could be obtained. In a case where the additive amount of the oxide of Mg was out of the range of the invention, sintering failure was caused or the specific resistance in the high temperature environment was lower than 100 MΩ·m, and the high temperature acceleration life time property was less than 10,000 sec at 200° C.—20 V/μm.

Based on the result for samples Nos. 20 to 25 within the additive amount of the oxide of the transition metal (Mn) being increased or decreased, dielectric ceramics having temperature characteristics capable of satisfying the X8R characteristics and having a specific resistance of 100 MΩ·m or higher in a high temperature environment could be obtained by defining the additive amount to a range from 0.03 mol to 0.60 mol based on 100 mol of the main ingredient and, further, a multi-layer ceramic capacitor having a high temperature acceleration life time property of 10,000 sec or more at 200° C.—20 V/μm could be obtained. In a case where the additive amount of the oxide of Mn was out of the range of the invention, the specific resistance in the high temperature environment was lower than 100 MΩ·m.

Based on the result for samples Nos. 26 to 34 in which the rare earth metal was substituted by rare earth metals other than Ho, the same effect was obtained also in a case of substituting the rare earth metal by those other than Ho. Further, based on the result for the sample No. 35 using two kinds of rare earth metals, i.e., Ho and Dy, the same effect was obtained also by using two types of rare earth element.

Based on the result for sample Nos. 36 to 37 in which the transition metal was substituted by transition metals other than Mn, same effect was obtained also in a case of substituting Mn by V or Cr. Further, based on the result for sample No. 38 using two kinds of transition metals, i.e., V and Mn, the same effect was obtained also by using two types of transition metals.

From the result described above, the invention can provide a multi-layer ceramic capacitor having temperature characteristics capable of satisfying the X8R characteristics, and a specific resistance of 100 MΩ·m or higher in a high temperature environment and, further, a high temperature acceleration life time property of 10,000 or more at 200° C.—20 V/μm. Further, the invention can provide dielectric ceramics for use in the multi-layer ceramic capacitor having the characteristics as described above.

What is claimed is:

1. A dielectric ceramics comprising:
a compound having a perovskite structure represented by:
(Bi_{0.5}Na_{0.5})ₓBa₁₋ₓTiO₃
in which x is from 0.05 to 0.2 as a first ingredient;
from 0.25 mol to 1.50 mol of at least one rare earth metal selected from Sm, Eu, Gd, Tb, Dy, Ho, Er, Tm, Yb, and Y, being converted as an oxide of one atom in one molecule based on 100 mol of the first ingredient;
from 0.20 mol to 1.5 mol of Mg being converted as an oxide of one atom in one molecule, based on 100 mol of the first ingredient;
from 0.03 mol to 0.60 mol of at least one metal selected from V, Cr, and Mn being converted as an oxide of one atom in one molecule, based on 100 mol of the first ingredient; and
SiO₂ or a glass ingredient mainly comprising SiO₂.

2. A multi-layer ceramic capacitor having multi-layer ceramics of a substantially hexahedral shape, internal electrodes formed in the multi-layer ceramics such that they are opposed in the multi-layer ceramics by way of the dielectric ceramics and led to different end faces alternately, and external electrodes formed on both end faces of the multi-layer ceramics and electrically connected with the internal electrodes led to the end faces respectively, in which a dielectric ceramics comprising:
a compound having a perovskite structure represented by:
(Bi_{0.5}Na_{0.5})ₓBa₁₋ₓTiO₃
in which x is from 0.05 to 0.2 as a first ingredient;
from 0.25 mol to 1.5 mol of at least one rare earth metal selected from Sm, Eu, Gd, Tb, Dy, Ho, Er, Tm, Yb, and Y, being converted as an oxide of one atom in one molecule, from 0.2 mol to 1.5 mol of Mg being converted as an oxide of one atom in one molecule, based on 100 mol of the first ingredient;
from 0.03 mol to 0.60 mol of at least one metal selected from V, Cr, and Mn being converted as an oxide of an atom in one molecule, based on 100 mol of the first ingredient;
SiO₂ or a glass ingredient mainly comprising SiO₂; and
the internal electrode is formed of Ni or an Ni alloy.

3. A ceramic composition comprising:
(Bi_{0.5}Na_{0.5})ₓBa₁₋ₓTiO₃, and, for every 100 mol of (Bi_{0.5}Na_{0.5})ₓBa₁₋ₓTiO₃:
0.25 to 1.5 mol of at least one rare earth metal selected from Sm, Eu, Gd, Tb, Dy, Ho, Er, Tm, Yb, and Y;
0.03 to 0.60 mol of at least one metal selected from V, Cr, and Mn; and
0.2 to 1.5 mol of Mg.

4. The composition of claim 3, wherein the composition further comprises a sintering aid.
